(19) United States
(12) Patent Application Publication
(10) Pub. No.: US 2003/0135929 A1
(43) Pub. Date: Jul. 24, 2003

(54) Buttocksrest pad

(76) Inventors: Nathaniel J. Dennison, Bronx, NY (US); Elihu Hassell McMahon, Bronx, NY (US)

Correspondence Address: David L. Heath, Greenberg Traurig, LLP, 885 Third Avenue, New York, NY, 10022, US

(21) Appl. No.: 10/055,541

(22) Filed: Jan. 23, 2002

(51) Int. Cl. A47C 27/10; A61G 7/057

(52) U.S. Cl. 5/713; 5/653; 5/421

(57) ABSTRACT

A bed rest apparatus for supporting a human body and relieving bedsores includes a compressible pad that encloses a plurality of crosswise fluid-filled channels. The crosswise channels are closed on one end and open on the other end. The compressible pad is placed upon a mattress or chair to support as patient. The apparatus further includes a fluid pump distributor with an attached fluid reservoir and a plurality of flexible transfer tubes that connect the open end of each crosswise channel to the fluid pump distributor. The pump distributor delivers fluid from the fluid reservoir to the flexible transfer tubes to fill the crosswise channels with fluid. The pump distributor temporally varies the pressure of the fluid in the crosswise channels, thus relieving pressure points on the patient and preventing bedsores.

### FIELD OF THE INVENTION

This invention is directed to an apparatus used to vary the pressure supporting a patient confined to a bed for the purpose of relieving bedsores and other pressure points.

### BACKGROUND OF THE INVENTION

Decubitus ulcers, otherwise known as bedsores, are of significant concern for bedridden patients. Bedsores have also become a problem for airline passengers on long distance flights and have been implicated in heart attacks caused by blood clots. These sores arise when certain parts of the body repeatedly experience high pressure for extended time periods, which interferes with the circulation of the blood. This is particularly true of natural bony projections, such as the scapula, sacrum and trochanter. Normally, when a person is at rest or asleep on a mattress, there is a certain amount of natural body movement. This movement helps ensure that the skin at those parts of the body receiving the most pressure from the mattress, usually the bony projections, is not subject to excessive pressure over time. Unfortunately, many bedridden patients cannot move about on the bed sufficiently to avoid constant pressure on those bony projections. This pressure can partially or totally block the skin capillaries, causing the cells to atrophy, resulting in bedsores.

### SUMMARY OF THE INVENTION

It is therefore an object of the present invention to relieve one surface area of the body at a time in an organized and controlled manner. This facilitates relief from the pressure to which the body, and in particular the buttocks, is automatically subjected while a patient is lying in a supine position. The apparatus of the invention comprises a semi-compressible pad in which are embedded a plurality of deformable channels. The length of the pad can be that of the pelvis and thighs up to the length of a human body, with the deformable channels extending crosswise across the pad, and is intended to be placed on top of a mattress or recliner upon which a patient is laying. The invention further includes a pump and distributor that can dynamically direct the flow of pneumatic fluid through the channels back and forth from top to bottom, and can automatically reverse itself to direct the flow from bottom to top. The invention can also include heating unit that can be used to set and control the temperature of the pneumatic fluid.

For patients who need to be prevented from moving from a particular angle of reclination, the apparatus of the invention can optionally include straps to secure the patient from sliding into an undesired position. Even in this situation, the dynamically varying fluid pressure of the channels can still relieve the pressure points of the patient, thus relieving bedsores.

This device can be used with orthopedic patients, intensive-care-unit patients, many quadriplegic and paraplegic patients as well as many patients receiving long-term-care in facilities such as nursing homes. The device can also be adapted for in-home use, and for use on airline passenger seats.

### BRIEF DESCRIPTION OF THE DRAWINGS

FIG. 1a depicts a perspective view of the bed rest pad of the invention, along with the patient anti-slide device.

FIG. 1b depicts a side view of the bed rest pad and patient anti-slide device of the invention.

FIG. 2a is a side view of an alternative embodiment of the bed rest pad of the invention, showing how it supports a patient.

FIG. 2b depicts a depression of a bed rest pad caused by a bony projection.

FIG. 2c depicts the materials from which a preferred embodiment of the bed rest pad is constructed.

FIG. 3a depicts a preferred embodiment of the bed rest pad supporting a patient.

FIG. 3b depicts a detailed view of how the preferred embodiment of FIG. 3a relieves pressure when depressed.

FIG. 3c depicts a schematic cut-away view of a fluid distributor.

FIG. 4a depicts side view of an alternative embodiment of the bed rest pad, with depressions.

FIG. 4b depicts a perspective view of the bed rest pad with flexible tubes connecting to the fluid distributor.

FIG. 5 depicts a schematic view of the system of the invention.

FIG. 6a depicts a perspective view of an embodiment of the bed rest pad that supports an entire human body.

FIG. 6b depicts a detail of a cut-away side view of the bed rest pad of the invention.

FIG. 7a depicts a cut-away side view of the bed rest pad of the invention.

FIG. 7b depicts a detail of a perspective view of the bed rest pad showing the transfer tubes.

### DETAILED DESCRIPTION OF THE INVENTION

One preferred embodiment of the invention is intended to support the pelvis and thighs. For the purposes of describing this invention, the pelvis includes the hip bone, the sacrum and the coccyx bones, and the head of the upper femur which fits into the acetabulum of the hip bone. The hip bone itself includes the ilium, the pubis, and the ischium bones.

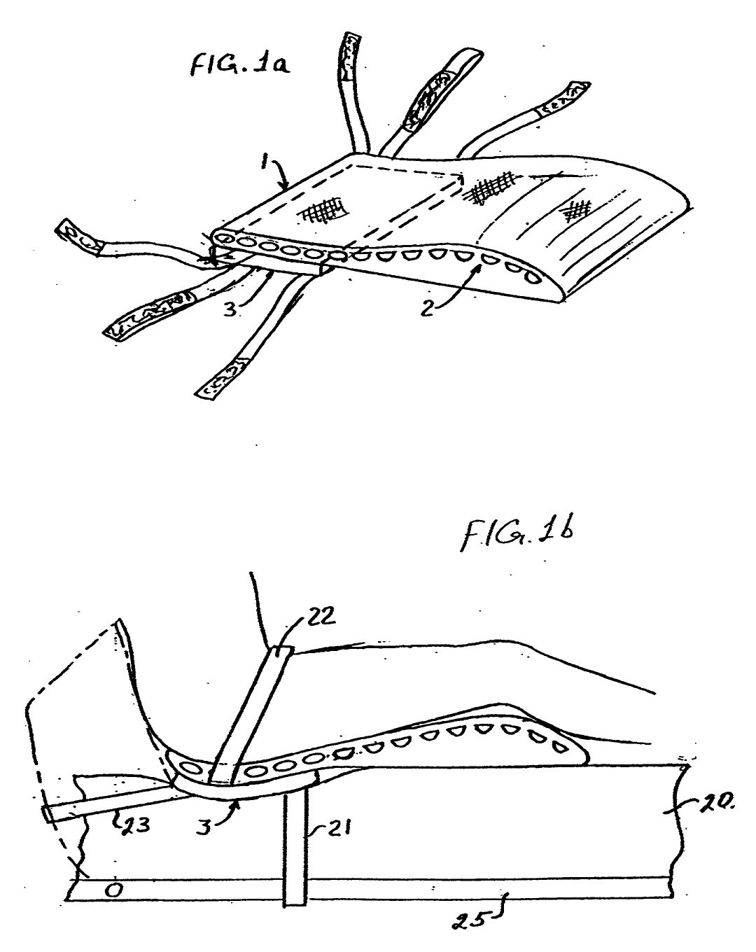

A perspective view of the bed rest pad of this embodiment of invention is depicted in FIG. 1a. The bed rest pad 1, being generally dimensioned to fit underneath a patient's buttocks and upper thighs, has disposed crosswise within it a plurality of fluid filled channels 2. On one side of the bed rest pad 1 the channels 2 are closed off, while on the other side the channels 2 are open. In a preferred embodiment of the bed rest pad 1, a side view of which is shown in FIG. 1b, the bed rest pad 1 is thicker near one end to accommodate raising the patient's thighs above the bed surface when the patient is in a supine position without constricting arterial or venous flow.

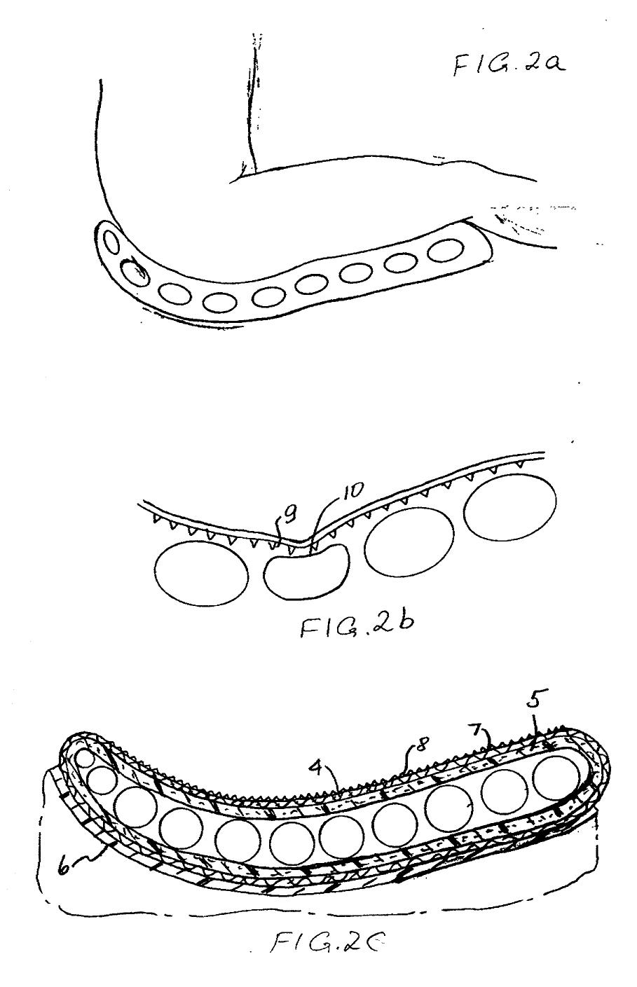

The bed rest pad 1 itself includes a flexible cover 4 enclosing a semi-compressible core 5, as shown in FIG. 2c. The core material should be soft and flexible, but non-crumbly, so that the bed rest unit 1 can contour to both a mattress surface and a patient's figure when a patient is resting upon it. One preferred material for the semi-compressible core 5 is closed-cell foam rubber. The cover can be manufactured from any flexible material, such as cloth, synthetic fabric, or plastic. In a preferred embodiment, the cover is a water-proof soft cotton fabric. The upper surface 7 of the cover 4 can also be embedded with a plurality of grooves 8 that extend laterally across the width of the bed rest pad 1 that serve to help prevent a patient from sliding off of the bed rest pad 1. The underside of the bed rest pad 1 can also include a rigid plate 6, preferably manufactured from plastic. The rigid plate 6 helps the channels maintain their shape as pressure is varied in the channels 2.

FIG. 2a depicts a side view of an alternative embodiment of the bed rest pad 1, wherein the thickness of the bed rest pad 1 is relatively uniform along the length of the pad. In addition, FIG. 2a depicts how such a pad would support a patient resting upon it. FIG. 2b depicts a bony projection 9, such as the scapula, sacrum or trochanter, pressing into the bed rest pad 1. The bony projection 9 causes a depression 10 in one of the fluid-filled channels 2 inside the bed rest pad 1, thus relieving the pressure on the skin surface of the patient.

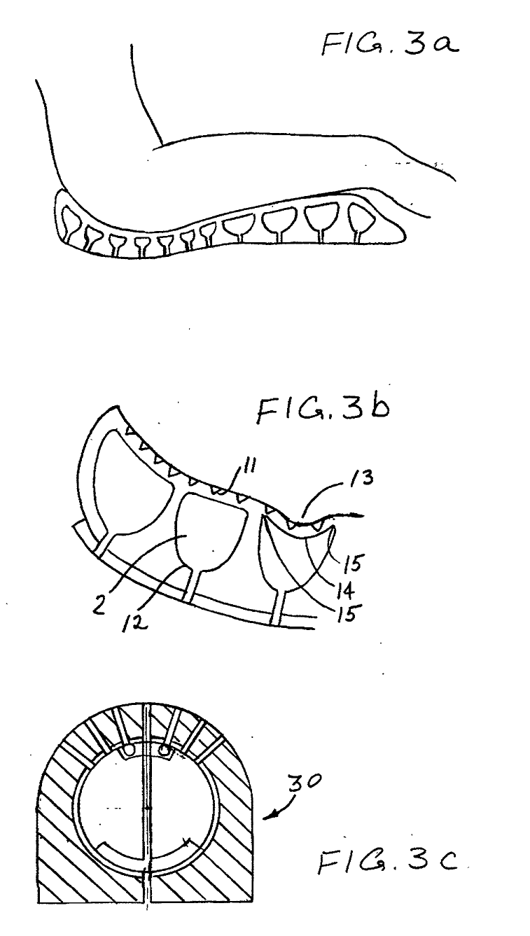

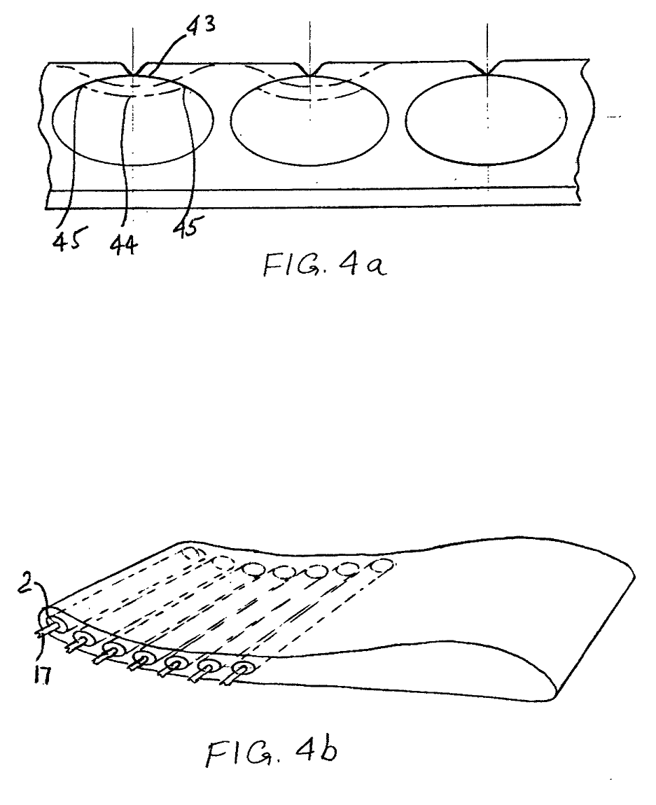

The cross-sectional shape of the channels 2 can take a variety of forms. In one embodiment, depicted in FIG. 2c, the cross-section of the channels 2 is circular in shape. In another embodiment, depicted in FIGS. 2a, 4a, 6b, and 7a, the cross sectional shape of the channels 2 is elliptical. In a third embodiment of the channels, depicted in FIGS. 3a and 3b, the channels have a cup-shaped cross-section, with the cross-section being relatively flat at an upper channel wall 11 proximal to the upper surface 7 of the bed rest pad 1, and having a lower wall 12 of the channel 2 that is rounded or semi-circular. The relatively flat upper wall 14 of the cup-shaped channel can provide support to a patient even when depressed by a bony projection, as shown in FIG. 3b. A bony projection 13 causes a depression 14 in a channel 16, however, the edges 15 of the relatively flat upper wall 11 are still providing support to the patient. By way of comparison, FIG. 4a depicts an elliptically shaped channel 42 subject to a projection 43, causing a depression 44 in the channel 42. The elliptical channels collapse better than the cup-shaped channels when fluid pressure in the channel is reduced.

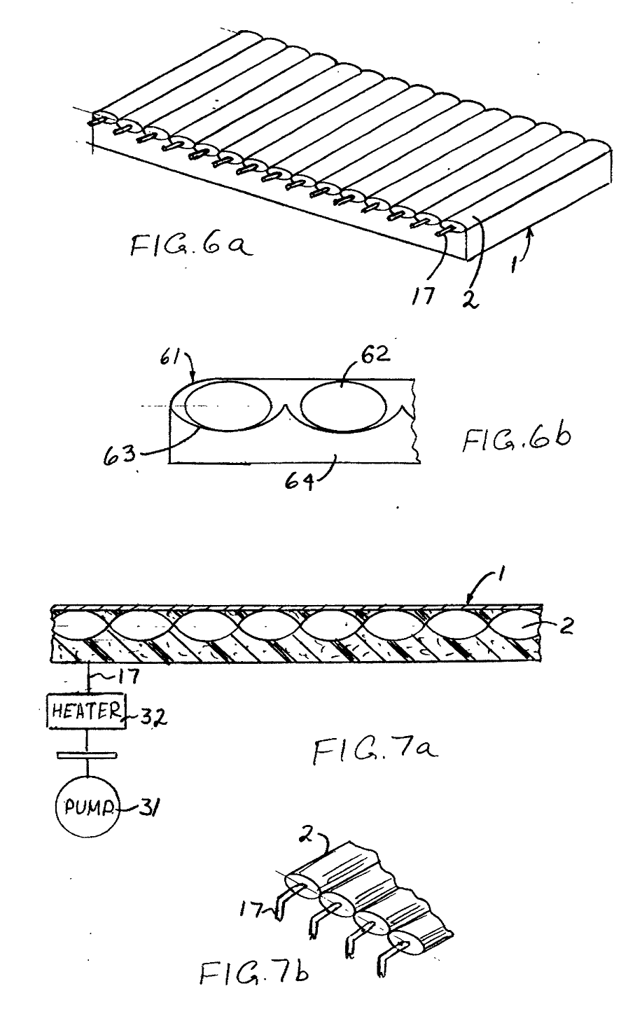

In a preferred embodiment, the upper walls of the channels 2 should be manufactured from a flexible material so that the channels can deform when subject to a projection or due to the weight of the patient, while the lower walls should be relatively rigid so as to maintain their shape even when the upper surfaces are deformed, as depicted in FIGS. 6b and 7a. These materials should be impermeable so as to prevent the fluid contained within the channels from seeping out of the channels and into the core material. Any of a variety of flexible and rigid impermeable plastic materials can be used for the manufacture of the channels, as are well known in the art. By way of contrast, if the channels 2 are completely flexible, then a rigid plate underlying the bed rest pad 1 is desirable, as shown in FIG. 2c.

However, in a most preferred embodiment, depicted in FIG. 6b, the channels 62 are manufactured of flexible material, and a rigid cup 63 shaped to follow the contour of the lower portion of the channel is embedded in the bed rest pad 61 with a space filled with a foam-like material 64 between the lower portion of the channel 62 and the rigid cup 63. This allows the channel to completely relieve pressure on a patient's body.

The channels 2 can be filled with any of a variety of pneumatic fluid materials. A preferred pneumatic fluid material should be relatively incompressible, so that the application of pressure to the top of the channel causes the channel to change shape in a direction perpendicular to the direction of the pressure. Examples of preferred fluids include compressed air, water, and liquid silicone. The use of a semi-compressible core material 5 surrounding the channels 2 permits the channels 2 to alter shape in response to an applied pressure.

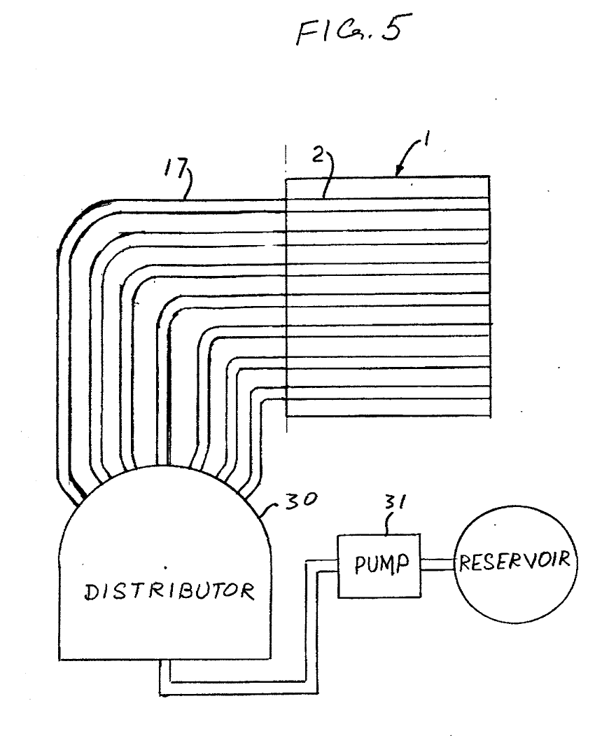

The open end of each channel 2 is connected via a flexible transfer tube 17, as shown in FIG. 4b, to a fluid distributor 30, shown in FIG. 3c, which is connected in turn to a vacuum pump. Vacuum fluid pumps and distributors are well known in the art, and are available as an integrated unit. The fluid distributor 30 is designed to temporally vary the fluid pressure in the channels 2 by selectively pumping fluid into different channels 2 at different times. A schematic of the bed rest unit 1, the flexible transfer tubes 17, the fluid distributor 30, and vacuum pump 31 is depicted in FIG. 5. The fluid distributor 30 thus routinely and methodically varies the pressure on a bedridden patient's pelvis and thigh's. The fluid distributor 30 can optionally include a micro-controller, which can be programmed to produce virtually any temporal pattern of fluid pressure change in the channels. Fluid distributors are also well known in the art. One exemplary temporal pressure action pattern is to have a pressure change move back and forth from top to bottom and back among the channels 2 in the bed rest pad 1. This temporal pressure variation of the fluid filled channels 2 helps relieve pressure points on a patient's body, and thus helps to prevent bedsores. This pressure action can also aid in maintaining a patient's circulation. In addition, the pump 31 and distributor 30 can optionally include a heating unit with a temperature controller that enables a technician to control the temperature of the pneumatic fluid.

Another aspect of the invention is a patient anti-slide device 3, depicted in FIGS. 1a and 1b, intended for use with a bed frame that pivots to raise a patient from a prone position to a sitting or reclining position. This anti-slide device 3 is used in conjunction with the bed rest device 1 to prevent a patient who is sitting at least partially upright from sliding off of the bed rest device. As shown in FIG. 1b, the anti-slide device 3 is disposed underneath the bed rest device 3 but on top of a mattress 20. The anti-slide device 3 is also provided with a plurality of straps to hold the anti-slide device and the patient in place: (1) a longitudinal frame strap 21 to secure the anti-slide device 3 to a longitudinal portion of a bed frame 25; (2) a patient strap 22 to secure a patient to the bed rest device 1; and (3) a vertical frame strap 23 to secure the anti-slide device 3 to the portion of the bed frame 25 that has pivoted into a raised position. Thus, a patient can be raised by an angle of up to 45° without sliding off of the bed rest unit 1. In addition, even though a patient is strapped in place by the patient strap 22 of the anti-slide device 3, the dynamic pressure variance action of the bed rest unit 1 can help prevent the patient from developing bedsores.

Even though the bed rest pad of the invention has been described in terms of an embodiment supporting the pelvis and thighs, the bed rest pad of the invention is not limited to that embodiment. A bed rest pad of the invention can be of any length, and in an alternative embodiment, can be long enough to support a full human body from neck to feet, as shown in FIG. 6a.

The system of the invention is not limited to the embodiments disclosed herein. It will be immediately apparent to those skilled in the art that variations and modifications to the disclosed embodiment are possible without departing from the spirit and scope of the present invention. The invention is defined by the appended claims.

What is claimed is:

1. An bed rest apparatus for supporting a human body and relieving bedsores, said apparatus comprising:
a semi-compressible pad, said pad enclosing a plurality of crosswise channels, wherein on a first side of the pad a first end of each crosswise channel is closed off, and on a second side of the pad a second end of each crosswise channel is open;
a plurality of flexible transfer tubes; and
a pump distributor to deliver fluid from a fluid reservoir to the to the plurality of flexible transfer tubes, wherein each flexible transfer tube connects the open, second end of each crosswise channel to the pump distributor, and wherein the crosswise channels are filled with fluid under pressure and the pump distributor temporally varies the pressure of the fluid in the crosswise channels, thus relieving pressure points on the patient and preventing bedsores.

2. The bed rest apparatus of claim 1, further comprising a patient anti-slide device, said anti-slide device comprising a pad that includes a plurality of straps, wherein said anti-slide device is dimensioned to fit underneath the semi-compressible pad, wherein the plurality of straps serve to strap the anti-slide device to a bed frame and to strap a patient to the semi-compressible pad.

3. The bed rest apparatus of claim 2, wherein the pad of the anti-slide device includes a first set of straps to hold the anti-slide device to a horizontal bed frame member, a second set of straps to hold the anti-slide device to a raised bed frame member, and a third set of straps to hold a patient to the compressible pad.

4. The bed rest apparatus of claim 1, wherein the semi-compressible pad is manufactured from a non-crumbly semi-compressible material.

5. The bed rest apparatus of claim 4, wherein the non-crumbly semi-compressible material is foam rubber.

6. The bed rest apparatus of claim 1, wherein the semi-compressible pad includes a water proof cover, wherein the cover can be manufactured from either cloth, synthetic fabric, or flexible plastic.

7. The bed rest apparatus of claim 6, wherein said cover includes on an upper surface crosswise grooves to help prevent a patient who is sitting on said semi-compressible pad from sliding off of the semi-compressible pad.

8. The bed rest apparatus of claim 1, wherein each crosswise channel includes an upper wall and a lower wall, wherein the upper wall of each channel is manufactured from a flexible material that can deform under pressure, wherein the lower wall is manufactured from a rigid material, and wherein both the flexible material and the rigid material are impermeable to the fluid contained within the channel.

9. The bed rest apparatus of claim 1, wherein each channel has a cross sectional shape that is circular.

10. The bed rest apparatus of claim 1, wherein each channel has a cross sectional shape that is elliptical.

11. The bed rest apparatus of claim 1, wherein each channel has a cross sectional shape that is cup-shaped, wherein the upper wall of the channel is relatively flat, and the lower wall of the channel is rounded.

12. The bed rest apparatus of claim 1, wherein the semi-compressible pad is dimensioned to support the pelvis and thighs of a human body.

13. The bed rest apparatus of claim 1, wherein the semi-compressible pad is dimensioned to support an entire human body.

14. The bed rest apparatus of claim 1, wherein the semi-compressible pad includes an upper surface, said upper surface being recessed at one end so as to accommodate a patient's buttocks, and said upper surface being raised at the other end so as to elevate a patient's thighs into a raised position.

15. The bed rest apparatus of claim 1, wherein the pump distributor includes a micro-controller that can be programmed to temporally vary the fluid pressure in the crosswise channels.

16. The bed rest apparatus of claim 1, wherein the pump distributor includes a heating unit and means for controlling the temperature of the fluid.

17. The bed rest apparatus of claim 1, wherein the fluid is incompressible.

18. The bed rest apparatus of claim 16, wherein the fluid can be compressed air, water, or liquid silicone.

19. The bed rest apparatus of claim 1, further comprising a rigid plate disposed underneath the semi-compressible pad.

20. The bed rest apparatus of claim 18, wherein the rigid plate is manufactured from plastic.

21. The bed rest apparatus of claim 1, wherein each crosswise channel includes a wall manufactured from a flexible material that can deform under pressure, and wherein the bed rest apparatus further comprises a rigid cup spaced below each crosswise channel so that there is a space between a lower portion of the crosswise channel and the rigid cup, and wherein both the flexible material and the rigid cup are impermeable to the fluid contained within the channel.
